(19) United States
(12) Patent Application Publication
(10) Pub. No.: US 2022/0184957 A1
(43) Pub. Date: Jun. 16, 2022

(54) ORIFICE SHIELD

(71) Applicant: Hewlett-Packard Development Company, L.P., Spring, TX (US)

(72) Inventors: Chien-Hua Chen, Corvallis, OR (US); Katrina L. Lane, Corvallis, OR (US); Michael G. Groh, Corvallis, OR (US)

(73) Assignee: Hewlett-Packard Development Company, L.P., Spring, TX (US)

(21) Appl. No.: 17/414,232

(22) PCT Filed: Sep. 6, 2019
(86) PCT No.: PCT/US2019/049891

§ 371 Date: Jun. 15, 2021

(51) Int. Cl. B41J 2/16

(52) U.S. Cl. CPC B41J 2/1603; B41J 2/1606; B41J 2/1623; B41J 2002/14411; B41J 2/1646; B41J 2/1642; B41J 2/1631

(57) ABSTRACT

A fluid ejection head may include an integrated chamber-orifice layer forming an ejection chamber and an ejection orifice, a fluid actuator to eject fluid within the chamber through the ejection orifice, an orifice shield and an adhesive layer bonding the orifice shield to the integrated chamber-orifice layer.

### BACKGROUND

Fluid ejection heads selectively eject droplets of fluid through orifices in a fluid ejection face. Such fluid ejection heads may be part of a printer which selectively deposits droplets of fluid, in the form of ink, by way of non-limiting example, upon a print target. Such fluid ejection heads may also be used in various other applications such as additive manufacturing, environmental testing and biomedical diagnostics.

### BRIEF DESCRIPTION OF THE DRAWINGS

FIG. 1 is a sectional view illustrating portions of an example fluid ejection head.

FIG. 2 is a flow diagram of an example method for forming an example fluid ejection head.

FIG. 3 is a sectional view illustrating portions of an example fluid ejection head.

FIG. 4 is a sectional view illustrating portions of an example fluid ejection head.

FIG. 5 is a sectional view illustrating portions of an example fluid ejection head.

FIG. 6 is a sectional view illustrating portions of an example fluid ejection head.

FIG. 7 is a sectional view illustrating portions of an example fluid ejection head.

FIGS. 8A, 8B, 8C, 8D, 8E, 8F and 8G are sectional views illustrating an example method for forming example fluid ejection heads.

FIG. 9 is a block diagram schematically illustrating portions of an example fluid ejection system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example fluid ejection heads that include an integrated chamber-orifice layer. The integrated chamber-orifice layer comprises a single layer of material in which both an ejection chamber and an ejection orifice are formed. Because both the ejection chamber and the ejection orifice are formed in a single layer, the ejection chamber and the ejection orifice may be more precisely aligned relative to one another and relative to a fluid actuator used to eject fluid through the orifice. As a result, the integrated chamber-orifice layer may enhance print quality.

Although the use of the integrated chamber-orifice layer may enhance print performance and ease manufacturing, the materials that facilitate the integrated chamber-orifice layer may have other less than desirable properties. For example, the material used to form the integrated chamber-orifice layer may render portions of the head, such regions about the orifices, more susceptible to mechanical damage. To address such concerns, the disclosed example fluid ejection heads and example methods provide an orifice shield that is adhesively bonded over the integrated chamber-orifice layer. Because the orifice shield is adhesively bonded over the integrated chamber-orifice layer, the orifice shield may be separately formed prior to being bonded to the integrated chamber-orifice layer and may be formed from a wider selection of possible materials with less risk of damaging remaining portions of the fluid ejection head. The adhesively bonded orifice shield further facilitates customization of the fluid ejection head for particular fluid ejection tasks and environments.

Disclosed is an example ejection head. The example fluid ejection head may comprise an integrated chamber-orifice layer forming an ejection chamber and an ejection orifice, a fluid actuator to eject fluid within the chamber through the ejection orifice, an orifice shield and an adhesive layer bonding the orifice shield to the integrated chamber-orifice layer.

Disclosed is an example method for forming a fluid ejection head. The method may comprise providing an integrated chamber-orifice layer forming an ejection chamber and an ejection orifice, providing a fluid actuator to eject fluid from the ejection chamber through the ejection orifice and bonding of orifice shield to a surface of the integrated chamber-orifice layer.

Disclosed is an example method for forming a fluid ejection head. The example method may include forming a wafer comprising a substrate supporting fluid actuators and an integrated chamber-orifice layer. The integrated chamber-orifice layer may comprise ejection chambers and ejection orifices. The method further involves forming an orifice shield separate from the forming of the wafer. The orifice shield is bonded to the wafer, wherein the orifice shield comprises openings corresponding to the ejection orifices. The wafer may then be separated into fluid ejection dies. Each of the fluid ejection dies comprises a portion of the fluid actuators, the ejection chambers and the ejection orifices.

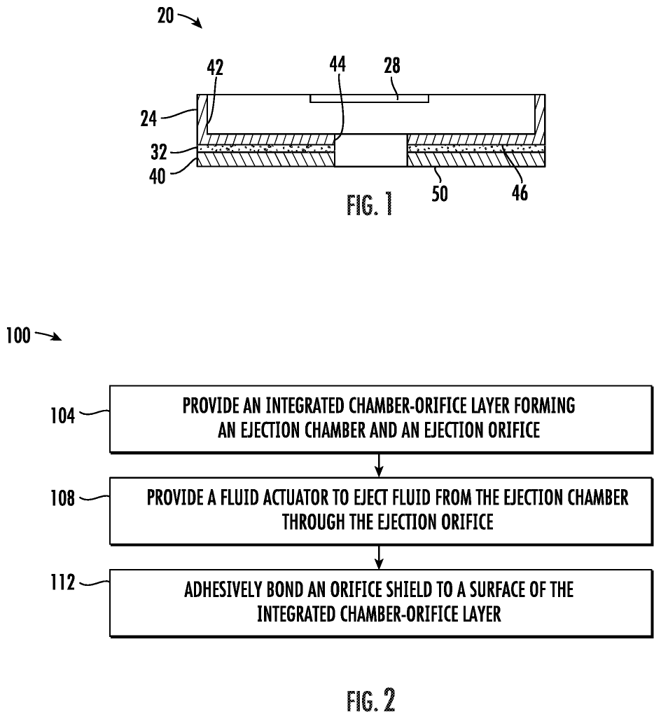

FIG. 1 is a sectional view illustrating portions of an example fluid ejection head 20. Fluid ejection head 20 comprises integrated chamber-orifice layer 24, fluid actuator 28, adhesive layer 32 and orifice shield 40. Integrated chamber-orifice layer 24 comprises a single layer of material forming both an ejection chamber 42 and an ejection orifice 44. Ejection chamber 42 comprises a space that is to contain fluid that is to be displaced by fluid actuator 28 through ejection orifice 44. Ejection orifice 44 comprises an opening extending through layer 24 (e.g., through a surface or face 46 of layer 24, face 46 representing an outer boundary of layer 24) and through which droplets of fluid are to be ejected. Absent additional coatings or shield 40, face 46 would otherwise form the fluid ejection face of head 20.

Chamber-orifice layer 24 is formed from a single layer of material that may be more easily molded, shaped, severed or otherwise altered to facilitate the forming of both the ejection chamber 42 and the ejection orifice 44. As will be described hereafter, because fluid ejection head 20 includes an adhesively bonded orifice shield 40, which assists in protecting layer 24 from mechanical damage, layer 24 may be formed from a wider selection of possible materials. In one implementation, the material forming chamber-orifice layer 24 comprises a polymer. In one implementation, the material forming chamber-orifice layer 24 comprises an epoxy. In one implementation, the material forming chamber orifice layer 24 comprises an epoxy-based photoresist material such as SU-8. In yet other implementations, chamber-orifice layer 24 may be formed from other materials including, but not limited to, benzocyclobutene (BCB), amorphous silicon, silicon oxide, and the like.

Fluid actuator 28 comprises an actuator that selectively controllably displaces fluid within fluid ejection chamber 42 through orifice 44. In one implementation, fluid actuator 28 may be supported by an overlying substrate from a material different than the material forming layer 24. In some implementations, fluid actuator 28 may be supported by a substrate formed of the same or similar materials as that of layer 24. In one implementation, fluid actuator 28 comprise a thermal resistor which, upon receiving electrical current, heats to a temperature above the nucleation temperature of the fluid so as to vaporize a portion of the adjacent fluid to create a bubble which displaces the fluid through the associated orifice 44. In other implementations, the fluid actuator 28 may comprise other forms of fluid actuators. In other implementations, the fluid actuator 28 may comprise a fluid actuator in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

Adhesive layer 32 comprises a layer of material on face 46 of layer 24 that assists in bonding the separately formed orifice shield 40 to the face 46 of the integrated chamber-orifice layer 24. In one implementation, adhesive layer 32 is deposited on face 46 prior to orifice shield 40 being brought into bonding contact with layer 32. In yet other implementations, adhesive layer 32 may be initially deposited upon a face of orifice shield 40 prior to adhesive layer 32 being brought into adhesive contact with face 46. In one implementation, adhesive layer 32 may be partially deposited upon both face 46 and upon a surface of orifice shield 40 prior to the bonding junction of orifice shield 40 to layer 24. In one implementation, adhesive layer 32 may be patterned and then stamped onto face 46 and/or shield 40. In another implementation, adhesive layer 32 may be patterned or otherwise deposited in other fashions, such as using masks or other fluid ejection heads that selectively deposit material. Examples of materials that may be used to form adhesive layer 32, include, but are not limited to, epoxy, poly(methyl methacrylate) (Acrylic), silicone, hot melt, and the like.

Although adhesive layer 32 is illustrated as directly bonding orifice shield 40 to face 46 of layer 24, in other implementations, adhesive layer 32 may indirectly bond orifice shield 40 to face 46 of layer 24. For example, fluid ejection face 46 of layer 24 may itself be coated with an additional layer or multiple additional layers, wherein adhesive layer 32 adhesively bonds the separately formed orifice shield 40 onto the external surface of the layer or layers coated upon layer 24.

Orifice shield 40 comprises a layer of material, different than that of the material forming layer 24, that is bonded to face 46 by adhesive layer 32. In implementations in which integrated chamber-orifice layer 24 is formed from a material that renders face 46 subject to mechanical damage, orifice shield 40 may be formed from a layer of material that has enhanced mechanical strength, integrity or robustness as compared to the material forming layer 24. In some implementations, orifice shield 40 may possess other mechanical properties different than that of the material forming face 46 of layer 24 or any materials coated upon face 46. For example, the material forming orifice shield 40 may have different wetting or non-wetting (surface energy) properties as compared to face 46 or an external layer coated upon face 46. In some implementations, orifice shield 40 may provide head 20 with a different surface texture as compared to face 46. For example, orifice shield 40 may provide fluid ejection head 20 with a new fluid ejection face 50 that, rather than being flat, is textured or has grooves, dimples or the like.

In one implementation, orifice shield 40 may comprise a layer or multiple layers of a material such as silicon. The silicon enhances the strength or robustness of the external face 50 of head 20 against impacts that might otherwise cause mechanical damage to layer 24 and its orifices (e.g., orifice 44). In yet other implementations, orifice shield 40 may be formed from a layer or multiple layers of material such as stainless steel, polymers, a glass, ceramics or the like. In one implementation, orifice shield may be formed from a group of materials consisting of a ceramic material, a metal, a glass, a polyamide, a polymer, and a non-wetting material. Because orifice shield 40 is separately formed and then subsequently bonded to layer 24, directly or indirectly, orifice shield 40 may be formed using materials and processes that involve heat, chemicals or the like that might otherwise be damaging to the materials of layer 24 if the layer of such materials were to be formed on layer 24 rather than being pre-formed and subsequently bonded to layer 24.

Although FIG. 1 illustrates fluid ejection head 20 as comprising a single fluid actuator 28, a single ejection chamber 42 and a single orifice 44, it should be appreciated that fluid ejection head may comprise a much larger number of actuators 28, ejection chambers 42 and orifices 44. For example, fluid ejection head 20 may comprise a two-dimensional array of such actuators 28, ejection chambers 42 and orifices 44. The fluid ejection chambers may be supplied with fluid from a local fluid supply, such as where head 20 is part of a fluid ejection cartridge. In other implementations, the fluid ejection chambers may be supplied with fluid from a remote or off-axis fluid supply.

FIG. 2 is a flow diagram of an example method 100 for forming a fluid ejection head. Although method 100 is described in the context of forming fluid ejection head 20, it should be appreciated that method 100 may likewise be utilized as part of a larger overall method for forming any of the later described fluid ejection heads or similar fluid ejection heads. As indicated by block 104, integrated chamber-orifice layer 24 is initially provided. Layer 24 forms both an ejection chamber 42 and an ejection orifice 44.

As indicated by block 108, a fluid actuator, such as fluid actuator 28, is further provided. Fluid actuator 28 is to eject fluid from the injection chamber 42 through the ejection orifice 44.

As indicated by block 112, orifice shield 40 is adhesively bonded, directly or indirectly, to a face 46 of the integrated chamber-orifice layer 24. As discussed above, orifice shield 40 is formed separately from the formation of layer 24. Orifice shield 40 provides the fluid ejection face of head 20 with material properties distinct from that of layer 24 or any coatings on layer 24.

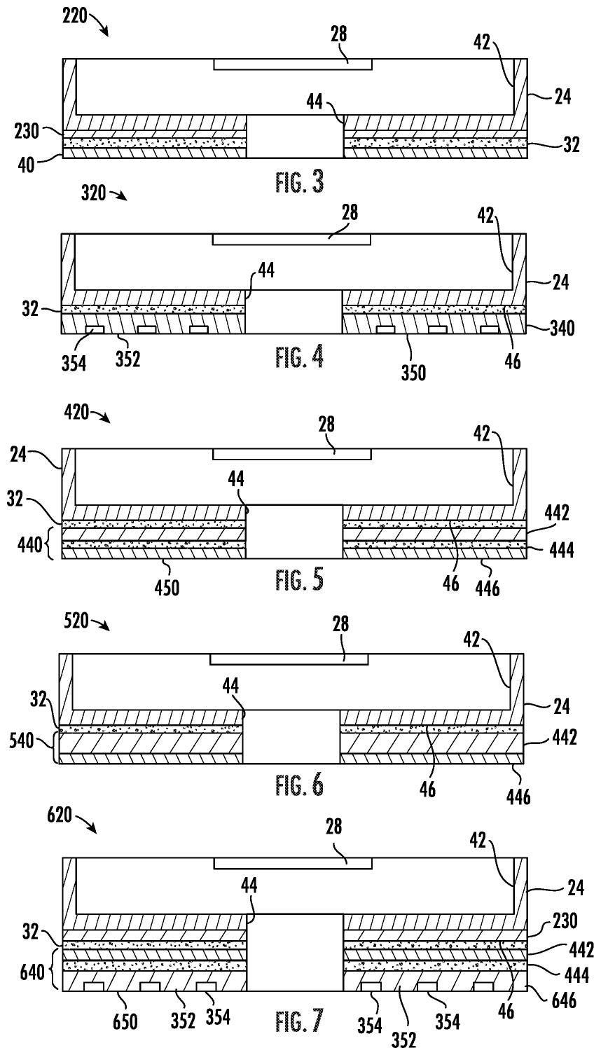

FIG. 3 is a sectional view illustrating portions of an example fluid ejection head 220. Fluid ejection head 220 is similar to fluid ejection head 20 described above except that fluid ejection head 220 comprises an intervening layer 230 coated upon face 46 of the integrated chamber-orifice layer 24. Those remaining components of ejection head 220 which correspond to components of ejection head 20 are numbered similarly. FIG. 3 illustrates how orifice shield 40 may be separately formed and indirectly bonded to layer 24 to enhance the properties of the fluid ejection face of head 220.

Intervening layer 230 comprises a layer that is directly formed on face 46 of layer 24. In one implementation, intervening layer 230 is coated as a fluid or liquid on face 46, wherein the fluid is cured or solidified on face 46. Because intervening layer 230 is formed, cured or solidified while residing on face 46 of layer 24, the materials or processes used to form intervening layer 230 may be restricted to avoid damage to layer 24. As described above, because orifice shield 40 is separately formed and then adhesively bonded to layer 24 as well as intervening layer 230, orifice shield 40 may be formed from materials and processes that would otherwise potentially damage layer 24 and/or intervening layer 230 if the material or materials of orifice shield 40 were formed, cured and/or solidified while directly residing on intervening layer 230.

FIG. 4 is a sectional view illustrating portions of an example fluid ejection head 320. Fluid ejection head 320 is similar to fluid ejection head 20 described above except that fluid ejection head 320 comprises orifice shield 340 in lieu of orifice shield 40. Those remaining components of fluid ejection head 320 which correspond to components of fluid ejection head 20 are numbered similarly. FIG. 4 illustrates the use of an orifice shield to alter a surface geometry of a fluid ejection face of a fluid ejection head.

Orifice shield 340 is similar to orifice shield 40 described above except that orifice shield 340 provides head 320 with a non-uniform or irregular fluid ejection face 350. Orifice shield 340 comprises a non-smooth surface texture. As shown by FIG. 4, face 350 comprises an array of bumps 352 and/or depressions 354. Depression 354 may be in the form of craters, channels, grooves, serrations or the like. The surface texture of face 350 may provide a different wetting or non-wetting property as compared to face 46 of layer 24 or that of any intervening layer, such as layer 230 described above.

As with shield 40, orifice shield 340 may be formed from a material that has different mechanical properties as compared to those of the material forming layer 24. Shield 340 may be formed from a material having enhanced strength, hardness flexibility or robustness as compared to the material forming layer 24. Shield 340 may be formed from a material having enhanced wetting capability or enhanced non-wetting capability as compared to the material of layer 24 any intervening layers that would otherwise form the fluid ejection face of fluid ejection head 320. Shield 340 may be formed from a material such as silicon, stainless steel, polymers, a glass, ceramics or the like.

FIG. 5 is a sectional view illustrating portions of an example fluid ejection head 420. Fluid ejection head 420 is similar to fluid ejection head 20 described above except that fluid ejection head 420 comprises orifice shield 440 in lieu of orifice shield 40. Those remaining components of fluid ejection had 420 which correspond to components of fluid ejection head 20 are numbered similarly. FIG. 5 illustrates how the orifice shield may comprise multiple different layers that are adhesively bonded to one another.

Like orifice shield 40, orifice shield 440 is adhesively bonded to the integrated chamber-orifice layer 24. Orifice shield 440 comprises a base layer 442, adhesive layer 444 and exterior layer 446. Base layer 442 and exterior layer 446 are adhesively bonded to one another by the intervening adhesive layer 444. In one implementation, base layer 442 is initially bonded to face 46 of layer 24 by adhesive layer 32, wherein exterior layer 446 is then bonded to base layer 442 by adhesive layer 444. In yet another implementation, layers 442 and 446 are initially bonded to one another by adhesive layer 444, separate from layer 24, wherein the bonded layers 442 and 446 are then brought into contact with adhesive layer 32 so as to be bonded to layer 24. The adhesive of adhesive layer 444 joining layers 442 and 446 may comprise an adhesive material such as epoxy, Acrylic, silicone, hot melt, and the like.

Each of layers 442 and 446 may have different material properties or characteristic as compared to the material forming layer 24. In one implementation, base layer 442 may be formed from a material having greater strength, flexibility, hardness or robustness as compared to the material forming layer 24. Base layer 442 protects layer 24 and ejection orifice 44 from damage caused by impacts to head 420. In one such implementations, base layer 442 may comprise a material such as silicon, a ceramic, a glass, a polymer, a metal, such as stainless steel, or the like. In one implementation, layer 442 is formed from a group of materials consisting of silicon, a metal, a polymer, a glass, and a ceramic.

Exterior layer 446 forms the fluid ejection face 450 of head 420. Exterior layer 446 and provide different material properties for face 450. For example, exterior layer 446 may in enhanced wetting surface or enhanced non-wetting surface. In enhanced wetting surface may lessen the puddling of fluid by spreading the fluid across face 50. An enhanced non-wetting surface may lessen puddling by repelling the accumulation of fluid along face 450. In one implementation, exterior layer 446 may comprise a lubricant, a polytetrafluoroethylene (TEFLON) layer or another layer of a silicon, ceramic, glass, polymer, metal or the like which cooperates with base layer 442 to protect layer 24. In one implementation, layer 446 is formed a material selected from a group of materials consisting of a ceramic material, a metal, a glass, a polyamide, a polymer, and a non-wetting material.

FIG. 6 is a sectional view illustrating portions of an example fluid ejection head 520. Fluid ejection head 520 is similar to fluid ejection head 420 except that fluid ejection head 520 comprises orifice shield 540 in place of orifice shield 440. Those remaining components of fluid ejection head 520 which correspond to components of fluid ejection had 420 are numbered similarly. FIG. 6 illustrates how an orifice shield may be formed by a base layer coated with a different layer.

As shown by FIG. 6, orifice shield 540 is similar to orifice shield 440 except that orifice shield 540 omits adhesive layer 444. Instead, exterior layer 446 is directly coated upon base layer 442. Such coating may be carried out by stamping, screen printing, spray coating, vacuum deposition, so-gel, sputtering, or controlled fluid deposition. Following such coating, the fluid forming exterior layer 446 cures or otherwise solidifies. In one implementation, base layer 442 is coated with external layer 446 prior to base layer 442 being adhesively bonded to layer 24 by adhesive layer 32. In yet another implementation, base layer 442 is initially bonded to layer 24 by adhesive layer 32 and then subsequently coated with external layer 446, wherein base layer 442 may protect layer 24 from any damage that might occur as a result of the forming of external layer 444 on base layer 442 after base layer 442 has already been bonded to the integrated chamber-orifice layer 24.

FIG. 7 is a sectional view of an example fluid ejection head 620. Fluid ejection head 620 incorporates many of the features described above with respect to FIGS. 3-5. Fluid ejection head 620 is similar to fluid ejection head 220 except that fluid ejection head 620 comprises orifice shield 640 in place of orifice shield 40. Those components of fluid ejection head 620 which correspond to components of fluid ejection heads 220, 320 and 420 are numbered similarly. FIG. 7 illustrates how the fluid ejection head may have an orifice shield adhesively bonded to a coated integrated chamber-orifice layer, how the orifice shield may be composed of multiple layers that are adhesively bonded to one another and how the orifice shield may alter the surface geometry/texture of the fluid ejection head.

Orifice shield 640 is similar to orifice shield 440 described above except that orifice shield 640 comprises external layer 646 in place of external layer 446. External layer 646 is similar to orifice shield 340 in that external layer 646 provides head 620 with a non-uniform or irregular fluid ejection face 650. Orifice shield 640 comprises a non-smooth surface texture. As shown by FIG. 7, fluid ejection face 650 comprises an array of bumps 352 and/or depressions 354. Depression 354 may be in the form of craters, channels, grooves, serrations or the like. The surface texture of face 350 may provide a different wetting or non-wetting property as compared to face 46 of layer 24 or that of any intervening layer, such as layer 230.

As with orifice shield 40, external layer 646 may be formed from a material that has different mechanical properties as compared to the material forming layer 24. External layer 646 may be formed from a material having enhanced strength, hardness flexibility or robustness as compared to the material forming layer 24. For example, layer 646 may be formed from a material such as silicon, stainless steel, polymers, a glass, ceramics or the like. External layer 646 may be formed from a material having enhanced wetting capability or enhanced non-wetting capability as compared to the material of layer 24 or any intervening layers that would otherwise form the fluid ejection face of fluid ejection head 620. For example, externally 646 may be formed from a layer of a lubricant or polytetrafluoroethylene. In some implementations, where external layer 446 is directly coated upon base layer 442, adhesive layer 444 may be omitted, such as illustrated by the implementation of orifice shield 540.

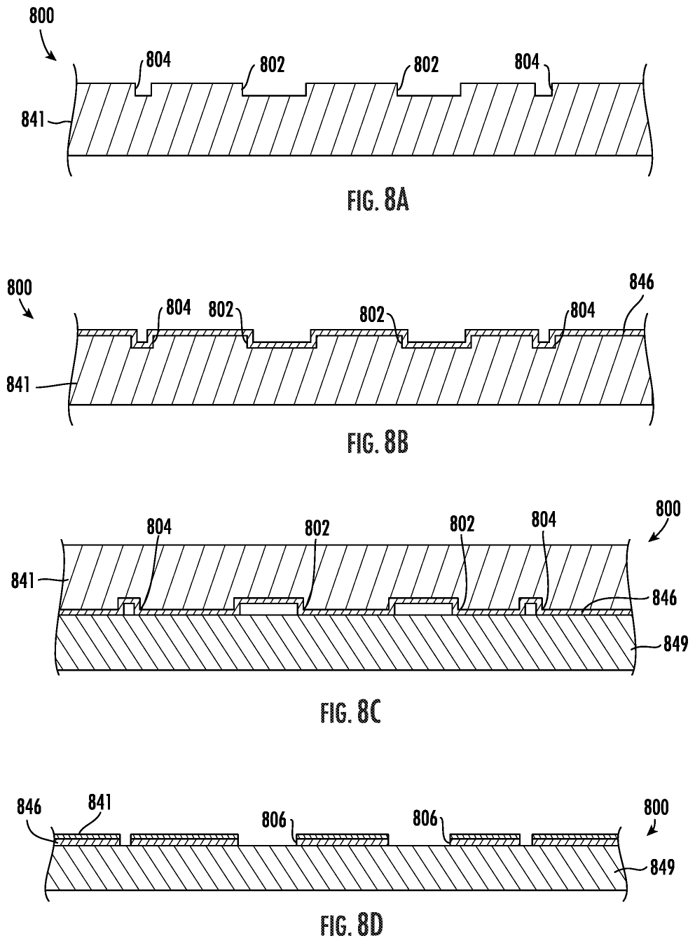

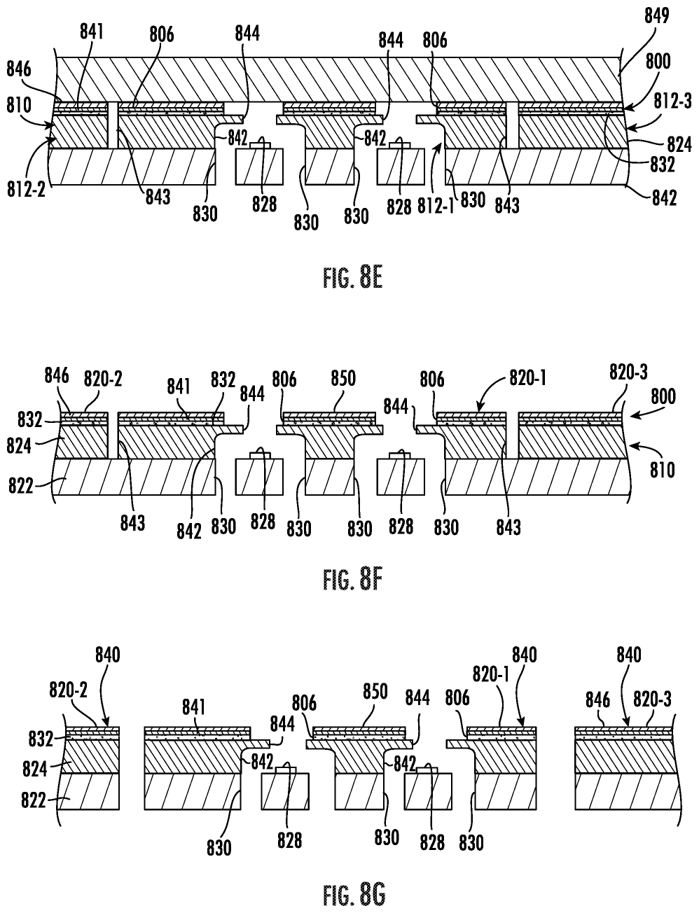

FIGS. 8A-8G illustrate one example of how an example fluid ejection head 820 (shown in FIG. 8F) may be formed. FIGS. 8A-8D illustrate the forming of an orifice shield wafer 800 providing a two-dimensional array of orifice shields 840 while FIGS. 8E and 8F illustrate the transfer and bonding of the formed orifice shield wafer 800 to a wafer 810 providing a corresponding two-dimensional array of fluid ejection devices 812-1, 812-2, 812-3 (collectively referred to as fluid ejection dies 812). FIG. 8F further illustrates the severing of the bonded wafers 800 and 810 into individual fluid ejection heads 820-1, 820-2 820-3 (collectively referred to as heads 820). Each of the fluid ejection heads 820 shown in FIG. 8G is similar to fluid ejection head 520 in that each fluid ejection head 820 comprises an orifice shield 840 having a base layer 841 that is coated with an external layer 846 for enhanced functionalization.

As shown by FIG. 8F, wafer 810 which is bonded to the separately formed orifice shield wafer 800, comprises a base substrate 822, an integrated chamber-orifice layer 824 and fluid actuators 828. Base substrate 822 defines fluid supply and circulation passages 830. Base substrate 822 further supports fluid actuators 828. In one implementation, substrate 822 comprises a layer of silicon. In other implementations, substrate 822 may be formed from other materials such as glass, ceramics, polymers and the like.

Integrated chamber-orifice layer 824 is similar to layer 24 described above. Layer 824 comprise a single layer of material that forms both fluid ejection chambers 842 and ejection orifices 844. In the example illustrated, layer 824 additionally comprises slits 843 to facilitate the severing of wafer 810 along such slits 843 into individual fluid ejection heads 820. In other implementations, such slits 843 may be omitted.

Chamber-orifice layer 824 is formed from a single layer of material that may be more easily molded, shaped, severed or otherwise altered to facilitate the forming of both the ejection chambers 842 and the ejection orifices 844. Because fluid ejection head 820 includes an adhesively bonded orifice shield 840, which assists in protecting layer 824 from mechanical damage, layer 824 may be formed from a wider selection of possible materials. In one implementation, the material forming chamber-orifice layer 824 comprises a polymer. In one implementation, the material forming chamber-orifice layer 824 comprises an epoxy. In one implementation, the material forming chamber orifice layer 824 comprises an epoxy-based photoresist material such as SU-8. In yet other implementations, chamber-orifice layer 824 may be formed from other materials including, but not limited to, BCB, amorphous silicon, silicon oxide, and the like.

As shown in FIG. 8A, a layer of material that will ultimately form a base layer 841 of the orifice shield wafer 800 is patterned. The pattern in the layer of material forms depressions 802 in the base layer 841 that correspond to the ejection orifices 844 of the wafer 810. In the example illustrated, the pattern in the layer forms additional depressions 804 that correspond to slits 843 for the severing or separation of the joined wafers into individual fluid ejection heads as shown in FIG. 8G. In one implementation, the layer 841 of material is patterned by photo etching. In one implementation, material of the layer 841 comprises silicon. In yet other implementations, the layer 841 of material may comprise other materials and may be patterned utilizing other techniques.

As shown in FIG. 8B, an additional exterior layer 846 is coated upon the pattern surface of base layer 841. In one implementation, layer 846 is coated upon layer 841 by stamping, screen printing, spray coating, vacuum deposition, so-gel, sputtering, or controlled fluid deposition. In the example illustrated, layer 846 is continuously coated across layer 841, wherein portions of the continuous layer 846 are subsequently removed through thinning as described hereafter with respect to FIG. 8D. In some implementations, layer 846 may be selectively printed upon or deposited upon selected portions of layer 841, wherein the material or materials of layer 846 are omitted at locations corresponding to ejection orifices 844.

Layer 846 is similar to exterior layer 446 described above. Exterior layer 846 forms the fluid ejection face 850 of each of heads 820. Exterior layer 846 provides different material properties for face 850. For example, exterior layer 846 may have an enhanced wetting surface or enhanced non-wetting surface. An enhanced wetting surface may lessen the puddling of fluid by spreading the fluid across face 850. An enhanced non-wetting surface may lessen puddling by repelling the accumulation of fluid along face 850. In one implementation, exterior layer 846 may comprise a lubricant, a polytetrafluoroethylene (TEFLON) layer or another layer of a silicon, ceramic, glass, polymer, metal or the like which cooperates with base layer 841 to protect layer 824.

As shown by FIG. 8C, layers 841 and 846, forming wafer 800, are temporarily bonded to a carrier 849. Carrier 849 serves as a support for wafer 800 as layer 841 is further altered and as wafer 800 is bonded to wafer 810. Carrier 849 may be formed from a variety of material such as electrostatic wafer carrier, metal carrier with thermal release tape, a glass carrier with temporary bonding material such as HT10.10 from Brewer Sciences and the like. In some implementations, carrier 849 may include additional features to facilitate the alignment of wafers 800 and 810.

As shown by FIG. 8D, layer 841 is thinned. Such thinning occurs to a depth below the height of depressions 802 and 804 so as transform such depressions into openings 806 corresponding to ejection orifices 844. In one implementation, layer 841 is thinned by mechanical grinder or chemical mechanical planarization. In one implementation where layer 841 is formed from silicon, layer 841 is thinned to a thickness of 30 um and no greater than 150 um. In other implementations, layer 841 may be thinned in other fashions or may be thinned to other thicknesses. In other implementations, such openings may be formed by drilling, etching or otherwise removing material in other fashions. In some implementations, such thinning may be omitted such as where layer 841 is initially provided with a chosen thickness and/or pattern.

Although wafer 800 of orifice shields 840 is disclosed as being initially formed separate from carrier 849 and then being temporarily bonded to carrier 849 for further processing (thinning), in other implementations, layer 841 may be initially deposited upon carrier 849 prior to being patterned. In such circumstances, layer 841 may be selectively deposited upon the carrier 849 with a chosen thickness and so as to form openings 806 corresponding to depressions 802 and 804. In such an implementation, layer 846 may be likewise patterned upon layer 841 with openings 806. With such an alternative process, the thinning described with respect to FIG. 8D to form the holes corresponding to ejection orifices 844 may be omitted.

FIG. 8E illustrates wafer 810 after portions of integrated chamber-orifice layer 824 have been coated with an adhesive forming adhesive layer 832. Adhesive layer 832 is similar to adhesive layer 32 described above. Adhesive layer 832 may be patterned upon the surface of wafer 810 so as to be omitted in locations corresponding to fluid ejection orifices 844 and slits 843. In one implementation, adhesive layer 832 may be stamped onto the surface of layer 824.

FIG. 8E further illustrates the positioning of wafer 800, supported by carrier 849 against the adhesive layer 832 on wafer 810 to bond wafers 800 and 810. FIG. 8F illustrates the bonded wafers 800 and 810 following the separation and withdrawal of carrier 849 from wafer 800. FIG. 8G illustrates the severing of the bonded wafers 800 and 810 into individual fluid ejection heads 820. Although each individual head 820 shown in FIG. 8G is illustrated as comprising a two rows of fluid ejection devices, in other implementations, each individual head 820 may include other numbers and arrangements of fluid ejection devices. Although FIGS. 8A-8G illustrate the forming of fluid ejection heads 820 which are similar to fluid ejection head 520 described above, it should be appreciated that similar processes may be used to form fluid ejection heads 20, 220, 320, 420 and 620 described above. Such alternative processes may omit or include additional process elements for adding additional layers to orifice shield wafer 800 or omitting particular layers from orifice shield wafer 800 prior to wafer 800 being bonded to wafer 810 in FIG. 8E.

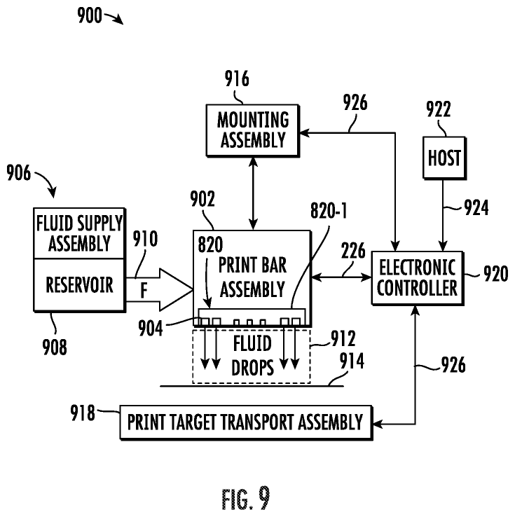

FIG. 9 is a block diagram schematically illustrating an example fluid ejection system 900 including fluid ejection head 820-1 (described above). Fluid ejection system 900 comprises a printbar 902, which includes a number of printheads 820 (one of which is shown), and an ink supply assembly 906. Fluid ejection system 900 is illustrated as utilizing printheads 820, in other implementations, fluid ejection system 900 may alternatively utilize fluid ejection heads 20, 220, 320, 420 or 620 described above.

The ink supply assembly 906 includes an ink reservoir 908. From the ink reservoir 908, a fluid (F) 910, such as ink, is provided to the printbar 902 to be fed to the fluid ejection heads 820. The fluid supply assembly 906 and printbar 902 may use a one-way fluid delivery system or a recirculating ink delivery system. In a one-way fluid delivery system, substantially all of the fluid supplied to the printbar 902 is consumed during printing. In a recirculating ink delivery system, a portion of the fluid 910 supplied to the printbar 902 is consumed during printing, and another portion of the fluid is returned to fluid supply assembly. In an example, the fluid supply assembly 906 is separate from the printbar 902, supplying the fluid 910 to the printbar 902 through a tubular connection, such as a supply tube (not shown). In other examples, the printbar 902 may include the ink supply assembly 906, and fluid reservoir 908, along with a printbar 902, for example, in single user printers. In either example, the ink reservoir 908 of the ink supply assembly 906 may be removed and replaced, or may be refilled.

From the printheads 820, the fluid 910 is ejected from nozzles or ejection orifices as fluid drops 912 towards a print target 914, such as paper, Mylar, cardstock, and the like. The print target 914 may be pretreated to improve print quality, for example, with a clear pretreatment. This may be performed in the printing system. The ejection orifices 844 of the printheads 904 are arranged in a column or array such that properly sequenced ejection of fluid 910 can form characters, symbols, graphics, or other images to be printed on the print target 914 as the printbar 902 and print target 914 are moved relative to each other. The fluid 910 is not limited to colored liquids used to form visible images on paper. For example, the fluid 910 may be an electro-active substance used to print circuits and other items, such as solar cells. In some examples, the fluid 910 may include a magnetic ink.

A mounting assembly 916 may be used to position the printbar 902 relative to the print target 914. In an example, the mounting assembly 916 may be in a fixed position, holding a number of fluid ejection heads 820 above the print target 914. In another example, the mounting assembly 916 may include a motor that moves the printbar 902 back and forth across the print target 914, for example, if the printbar 902 included one to four printheads 904. A print target transport assembly 918 moves the print target 914 relative to the printbar 902, for example, moving the print target 914 perpendicular to the printbar 902. In the example of FIG. 9, the print target transport assembly 918 may include the rolls as well as any number of motorized pinch rolls used to pull the paper, as a web, through the printing system 900. If the printbar 902 is moved, the print target transport assembly 918 may index the print target 914 to new positions. In examples in which the printbar 902 is not moved, the motion of the print target 914 may be continuous.

A controller 920 receives data from a host system 922, such as a computer. The data may be transmitted over a network connection 924, which may be an electrical connection, an optical fiber connection, or a wireless connection, among others. The data 920 may include a document or file to be printed, or may include more elemental items, such as a color plane of a document or a rasterized document. The controller 920 may temporarily store the data in a local memory for analysis. The analysis may include determining timing control for the ejection of ink drops from the printheads 904, as well as the motion of the print target 902 and any motion of the printbar 902. The controller 920 may operate the individual parts of the printing system over control lines 926. Accordingly, the controller 920 defines a pattern of ejected fluid drops 912 which form characters, symbols, graphics, or other images on the print target 914.

The ink jet printing system 900 is not limited to the items shown in FIG. 9. For example, the controller 920 may be a cluster computing system coupled in a network that has separate computing controls for individual parts of the system. For example, a separate controller may be associated with each of the mounting assembly 916, the printbar 902, the fluid supply assembly 906, and the print target transport assembly 918. In this example, the control lines 926 may be network connections coupling the separate controllers into a single network. In other examples, the mounting assembly 916 may not be a separate item from the printbar 902, for example, if the printbar 902 is fixed in place.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A fluid ejection head comprising:
an integrated chamber-orifice layer forming an ejection chamber and an ejection orifice;
a fluid actuator to eject fluid within the chamber through the ejection orifice;
an orifice shield; and
an adhesive layer bonding the orifice shield to the integrated chamber-orifice layer.

2. The fluid ejection head of claim 1, wherein the chamber-orifice layer comprises a photoresist material.

3. The fluid ejection head of claim 2, wherein the orifice shield comprises a layer of a material selected from a group of materials consisting of silicon, a metal, a polymer, a glass, and a ceramic.

4. The fluid ejection head of claim 3, wherein the layer of material of the orifice shield comprises silicon.

5. The fluid ejection head of claim 4, wherein the layer of material of the orifice shield comprises a surface texture.

6. The fluid ejection head of claim 5, wherein the orifice shield comprises a second layer of a second material, the second material being different than the material.

7. The fluid ejection head of claim 6, wherein the second layer is coated upon the layer of the material.

8. The fluid ejection head of claim 6 further comprising an adhesive bonding the second layer to the layer.

9. The fluid ejection head of claim 6, wherein the second material comprises a material selected from a group of materials consisting of a ceramic material, a metal, a glass, a polyamide, a polymer, and a non-wetting material.

10. A method for forming a fluid ejection head, the method comprising:
providing an integrated chamber-orifice layer forming an ejection chamber and an ejection orifice;
providing a fluid actuator to eject fluid from the ejection chamber through the ejection orifice; and
bonding an orifice shield to a surface of the integrated chamber-orifice layer.

11. The method of claim 10 further comprising forming the orifice shield separate from the integrated chamber-orifice layer.

12. The method of claim 11, wherein the forming of the orifice shield comprises:
forming the orifice shield upon a carrier; and
transferring the orifice shield from the carrier to the integrated chamber-orifice layer.

13. The method of claim 10, wherein the integrated chamber-orifice layer comprises a photoresist material.

14. A method for forming a fluid ejection head, the method comprising:
forming a wafer comprising a substrate supporting fluid actuators and an integrated chamber-orifice layer, the integrated chamber-orifice layer comprising ejection chambers and ejection orifices;
forming an orifice shield separate from the forming of the wafer;
bonding the orifice shield to the wafer, the orifice shield comprising openings corresponding to the ejection orifices; and
separating the wafer into fluid ejection dies, each of the fluid ejection dies comprising a portion of the fluid actuators, the ejection chambers and the ejection orifices.

15. The method of claim 14, wherein the forming of the orifice shield separate from the forming the wafer comprises:
forming the orifice shield on a carrier; and
transferring the orifice shield from the carrier onto the wafer.
